(19) United States
(12) Patent Application Publication
(10) Pub. No.: US 2002/0077925 A1
(43) Pub. Date: Jun. 20, 2002

(54) Buying and selling system of secondhand books using the network of convenience stores

(76) Inventor: Mikio Fujita, Tokyo (JP)

Correspondence Address: Mikio FUJITA, 1 - 1002, Shimomaruko 2-24-10, Ohta-ku, Tokyo, 146-0092, JP

(21) Appl. No.: 09/747,411

(22) Filed: Dec. 20, 2000

(51) Int. Cl. G06F 17/60

(52) U.S. Cl. 705/26

(57) ABSTRACT

This is a business system that the trader buys secondhand books and sells them again using the network of convenience stores. The trader establishes the main server on Internet and also opens the homepage on the Web site. The trader makes contracts concerning buying and hand-over business of secondhand books with convenience stores. This system features that the payment of the second hand book is accepted at the convenient store or card payment is available for the order on Web site.

### BACK GROUND OF THE INVENTION

This invention is related to the convenient buying and selling system of secondhand books through the network of convenience store and the database of the published books.

In the past, purchasers or sellers of secondhand books had to visit the shops that handled secondhand books.

Or even when using the net, people had to select the secondhand books only from the stock of the trader.

Conventional method had the following inconveniences:

a. There are few numbers of specialty shops that handle secondhand books.

b. The price of secondhand books bought by specialty shops is constant, which means that the fixed price at the new publication is disregarded.

c. People who visit specialty shops to buy their desired secondhand book have to spend a long hours to find it.

d. The books of similar titles or series have difficulty in mutual comparison and confirmation.

e. When purchaser's memory is vague or wrong, it is impossible to confirm whether the searched book corresponds to the one the purchaser is looking for and the stock situation.

This invention is to use the network of the convenience store in order to buy/sell secondhand books easily to solve the above inconveniences.

### SUMMARY OF THE INVENTION

This is a business system that the trader buys secondhand books and sells them again using the network of convenience stores. The trader establishes the main server on Internet and also opens the homepage on the Web site. The trader makes contracts concerning buying and hand-over business of secondhand books with convenience stores.

The trader pays the commission for the business on the request to the convenience store within a certain period. The secondhand books brought in to the convenience store are bought by the amount set beforehand (for example, by 5% or 10% of fixed price etc.) Also, the buying prices are set beforehand according to the kinds of secondhand books such as novels, cartoons, dictionaries, magazines, and picture books. The secondhand boos bought at convenience stores are picked up by the collecting car of the trader and stored in the warehouse. The titles of the secondhand books stored in the warehouse are read with the scanner that synchronizes with the computer to make a database. The database can be used through the main server.

The person who wants to buy the secondhand book accesses to the trader's homepage through Internet to search the secondhand book through the database of the published books and places an order. Based on the input information of the purchaser's address at the book order, the ordered book can be received at a convenience store near the purchaser's address or the specified convenience store. Payment of the second hand book is accepted at the convenient store or card payment is available for the order on Web site. This is a buying and selling system of secondhand book through the network of convenience store which features the above.

### DETAILED DESCRIPTION OF THE INVENTION

The following explains the form to execute this invention:

A. Main server is established on Internet to use the database. The homepage is opened on the Web site. Home page is composed of the contents such as the database of published books, the search of secondhand books, order, payment method, the place for hand-over etc. The trader makes the business tie-up concerning buying and selling of secondhand books with the convenience store, followed by starting of this business.

The trader pays the sum of the amount that the convenience store paid for buying the secondhand books and the commission within a certain period. Convenience stores buy secondhand books that customers brought in by the amount that the trader has specified beforehand (for example, 5% or 10%of fixed price etc.).

The places to accept secondhand books, that is the convenience stores, undertake the bar code reading of the ISBN code attached to the books or input the numerical values. They check the database of the published books that are stored in the main server to confirm the fixed price and buying price of the book.

Books are purchased in accordance with this procedure and books with no data on the server are not purchased. The book can be registered as the stock at this time, but basically book registration has not completed until it is put in storage. Warehouse also undertakes to input the ISBN code.

B. The secondhand book bought at convenience stores are regularly collected by the trader and stored in the warehouse of the trader. The secondhand books that are stored are classified according to the book kind and the titles. The kinds of the secondhand books are input at the same time as reading their title names with the scanner that synchronizes with the computer.

Based on this input, the bar code printer connected to the computer prints out the bar code seals to paste on the secondhand books. The kinds and the titles of the secondhand books that are input to the computer are added to the database.

Input of ISBN code of the secondhand book by the bar code or the numerical value makes it possible to compare the secondhand book with the database of the published books and to obtain the information including titles, author names, classifications and prices, etc.

C. The person who desires to buy the secondhand book accesses trader's homepage for the search. When ordering the secondhand book that was searched in the home page, the purchaser inputs the payment method, address of the convenience store to receive the secondhand book, the date (the desired day after two days after order) and his/her address. In case that the address of the convenience store to receive the secondhand book is not specified, the computer selects the convenience store near the purchaser's address and displays it on the screen. This is the place where the purchaser receives the secondhand book. This is the mechanism that the purchaser of the secondhand book receives the secondhand book according to the receipt day, payment method and the address of the convenience store which are displayed on the screen after the input of the data.

In addition, this system can be extended to fast food chains, drugstore chains, video shops, liquor stores, stations etc. as well as the network of the convenience store.

This system permits searching the secondhand book that the customer looks for through the trader's homepage, ordering it, and receiving it at near-by convenience store or at the convenience store the purchaser visits often. Busy people receive the benefit that many convenience stores open 24 hours, because they can pick up the ordered book at any time.

As convenience stores buy unnecessary secondhand books brought in at certain amount, sellers of the secondhand book don't have to take their books that are expensive, but unnecessary to the specialty shop of secondhand books. This is the system that people buy and sell their secondhand books through near-by convenience stores and therefore contributes to recycling the resource. Furthermore, The member registration system offers adjusting the purchase price according to the sales results.

What is claimed is:

1] This is a business system that the trader buys unnecessary secondhand books and sells them again using the network of convenience stores. The trader establishes the main server on Internet and also opens the homepage on the Web site. The trader makes contracts concerning buying and hand-over business of secondhand books with convenience stores. The trader pays the commission for the business on the request to the convenience store within a certain period. The secondhand books brought in to the convenience store are bought by the amount set beforehand (for example, by 5% or 10% of fixed price etc.) Also, the buying prices are set beforehand according to the kinds of secondhand books such as novels, cartoons, dictionaries, magazines, and picture books. The secondhand books bought at convenience stores are picked up by the collecting car of the trader and stored in the warehouse. The titles of the secondhand books stored in the warehouse are read with the scanner that synchronizes with the computer to make a database. The database can be used through the main server. In addition, by adding the stock information to the database of published books that is set as a base, this system allows search objects to be extended to the entire book already published as well as the stocked books. It also permits the search by vague memory. The person who wants to buy the secondhand book accesses to the trader's homepage through Internet and searches the secondhand book through the database of published books and places an order. Based on the input information of their address at ordering the book, purchasers can receive the ordered book at a convenience store near their address or the convenience store they specified. Payment of the second hand book is accepted at the convenient store or card payment is available for the order on Web site. This is the buying and selling system of secondhand book that features the above through the network of convenience store.
